(19) United States
(12) Patent Application Publication
(10) Pub. No.: US 2008/0236288 A1
(43) Pub. Date: Oct. 2, 2008

(54) INSPECTION SYSTEMS AND METHODS FOR DETECTION OF MATERIAL PROPERTY ANOMALIES

(75) Inventors: Edward James Nieters, Burnt Hills, NY (US); Michael Francis Xavier Gigliotti, Scotia, NY (US); Ramkumar Kashyap Oruganti, Bangalore (IN); Sivaramanivas Ramaswamy, Bangalore (IN); Balachandar Ramadurai, Bangalore (IN); Vamshi Krishna Reddy Kommareddy, Bangalore (IN); Ganesan Baskaran, Bangalore (IN); Michael Everett Keller, Mason, OH (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/695,207

(22) Filed: Apr. 2, 2007

(51) Int. Cl. G01N 29/04

(52) U.S. Cl. 73/644

(57) ABSTRACT

A method for inspecting a part is provided. The method includes immersing the part in a couplant medium, delivering ultrasonic wave energy to at least one subvolume of the part using an ultrasonic transducer immersed in the couplant medium and receiving ultrasonic wave energy from the part at a fundamental frequency and at least one harmonic frequency using an ultrasonic receiver immersed in the couplant medium. The method also includes generating a nonlinear image corresponding to at least one material property variation of the part using the received ultrasonic energy and using the nonlinear image of the part to determine whether one or more material property anomalies are present in the part.

### BACKGROUND

The invention relates generally to inspection methods and, more particularly to, ultrasonic inspection methods for detection of material property anomalies in a part.

Inspection of material properties and damage of machined parts in components, such as aircraft engine rotating parts, is desirable to ensure structural integrity thereof. Further, inspection of microstructural damage is desirable to facilitate the prediction of the effects of such damage on the life cycle of the part. For example, service life of engine rotating parts is limited by the amount of fatigue cycles they experience. Additionally, the presence of cracks in a particular part may prevent that part from being repaired and returned to service. Typically, a region that has accumulated fatigue damage could be a region where an incipient failure occurs. The presence of an identified crack in the part signifies that the part has exhausted its life.

Typically, ultrasonic inspection techniques are being pursued to inspect such components. In operation, ultrasound signals or pulses are typically transmitted at fundamental frequencies, and echo signals are received by a transducer. Discontinuities, such as cracks, can be detected when their echoes are greater than that of the background noise. However, this technique is a time consuming process and is not amenable for contoured components and shop floor implementation.

Accordingly, it would be desirable to develop an inspection technique that provides an accurate material characterization of a part. Furthermore, it would be desirable to provide an inspection technique for imaging microstructural damage in a part.

### BRIEF DESCRIPTION

Briefly, according to one embodiment of the invention, a method for inspecting a part is provided. The method includes immersing the part in a couplant medium, delivering ultrasonic wave energy to at least one subvolume of the part using an ultrasonic transducer immersed in the couplant medium and receiving ultrasonic wave energy from the part at a fundamental frequency and at least one harmonic frequency using an ultrasonic receiver immersed in the couplant medium. The method also includes generating a nonlinear image corresponding to at least one material property variation of the part using the received ultrasonic energy and using the nonlinear image of the part to determine whether one or more material property anomalies are present in the part.

In another embodiment, a system for inspecting a part is provided. The system includes a container at least partially filled with a couplant medium and having the part immersed therein and an ultrasonic transducer immersed in the couplant medium and configured to deliver ultrasonic wave energy to at least one sub volume of the part. The system also includes an ultrasonic receiver immersed in the couplant medium and configured to receive ultrasonic wave energy from the part at a fundamental frequency and at least one harmonic frequency and a processor configured to generate a nonlinear image corresponding to a material property variation of the part using the received ultrasonic energy and to use the image of the part to determine whether one or more material property anomalies are present in the part.

### DRAWINGS

These and other features, aspects, and advantages of the present invention will become better understood when the following detailed description is read with reference to the accompanying drawings in which like characters represent like parts throughout the drawings, wherein:

FIG. 1 schematically depicts a life limiting part.

FIG. 2 is a diagrammatical representation of an ultrasonic inspection system.

FIG. 3 is a flow chart illustrating an ultrasonic inspection method.

FIG. 4 illustrates an exemplary input signal delivered to an inspection part using the ultrasonic inspection system of FIG. 2.

FIG. 5 illustrates an exemplary output signal received from the inspection part of FIG. 4.

FIG. 6 is a diagrammatical representation of an exemplary configuration of the ultrasonic transducer and the ultrasonic receiver employed in the ultrasonic inspection system of FIG. 2.

FIG. 7 is a diagrammatical representation of another exemplary configuration of the ultrasonic transducer and the ultrasonic receiver employed in the ultrasonic inspection system of FIG. 2.

FIG. 8 is a graphical representation of exemplary Beta (β) parameter values corresponding to low cycle fatigue damage obtained using the ultrasonic inspection system of FIG. 2.

FIG. 9 illustrates another exemplary configuration of an ultrasonic transducer and ultrasonic receiver for the ultrasonic inspection system of FIG. 2.

### DETAILED DESCRIPTION

As discussed in detail below, embodiments of the present invention function to provide an inspection technique that provides an accurate material characterization of a part. In particular, the present invention facilitates detection of material property anomalies in a part such as due to a low cycle fatigue, a high cycle fatigue, fretting fatigue etc through a nonlinear ultrasound and imaging technique. For example, an aircraft engine consists of various components such as fan disk, high pressure compressor, high pressure turbine and low pressure turbine. Such components are subjected to different types of thermo mechanical damage. Specifically, the hot section components experience an accelerated rate of damage such as due to low cycle fatigue and high cycle fatigue and such components are termed as life limiting parts since service life of such parts is limited by the amount of fatigue cycles they experience.

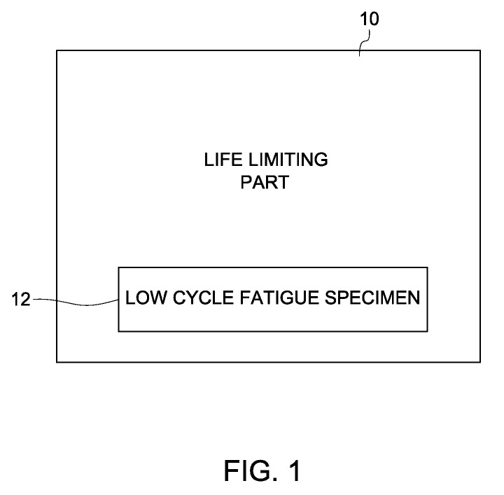

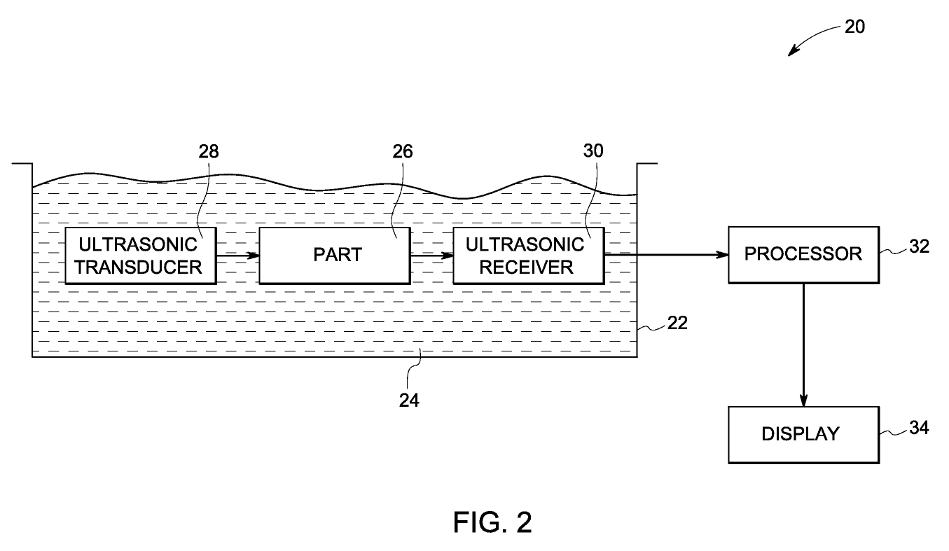

FIG. 1 schematically depicts an exemplary life limiting part such as a fan disk 10 of an aircraft engine. As illustrated, a low cycle fatigue specimen 12 may be extracted from the fan disk 10 for detecting and quantifying accumulated fatigue damage in the specimen 12. As used herein, term “low cycle fatigue” refers to fatigue of a rotating component caused due to continuous imposing and relaxing of a centrifugal force caused by a fluctuation in speed. It should be noted that a plurality of specimens 12 may be extracted from the fan disk 10 for detecting the presence of material property anomalies in the specimen corresponding to low cycle fatigue, high cycle fatigue and so forth. Such specimens 12 may be subjected to a fatigue cycle test and an inspection system may be employed for detecting damage due to the low cycle fatigue, as described below with reference to FIG. 2.

FIG. 2 is a diagrammatical representation of an ultrasonic inspection system 20. As illustrated, the ultrasonic inspection system 20 includes a container 22 at least partially filled with a couplant medium 24 and having a part 26 immersed therein. In the illustrated embodiment, the part 26 includes the low cycle fatigue specimen 12 (see FIG. 1) extracted from the fan disk 10 of FIG. 1. Examples of the couplant medium include water, alcohol and glycerine. However, a variety of other mediums that are capable of generating relatively lower level of harmonics as compared to the harmonics generated by the part 26 may be employed. The ultrasonic inspection system 20 also includes an ultrasonic transducer 28 immersed in the couplant medium 24 and configured to deliver ultrasonic wave energy to at least one sub volume of the part 26. In one exemplary embodiment, the ultrasonic transducer 28 is configured to deliver the ultrasonic energy at a frequency of about 5 MHz. In certain embodiments, the ultrasonic transducer 28 is configured to transmit pure tone signals, chirp signals and combinations thereof. Further, examples of the ultrasonic transducer 28 include a single element probe, a linear array, a phased array, laser ultrasound, electromagnetic acoustic transducers (EMATS), polyvinylidene fluoride (PVDF) probes and capacitive micromachined ultrasonic transducers (CMUTS).

Furthermore, the ultrasonic inspection system 20 includes an ultrasonic receiver 30 immersed in the couplant medium 24 and configured to receive ultrasonic wave energy from the part 26 at a fundamental frequency and at least one harmonic frequency. In one exemplary embodiment, the ultrasonic receiver 30 is configured to acquire the ultrasonic wave energy at a frequency in a range of about 5 MHz to about 10 MHZ. In this exemplary embodiment, the ultrasonic receiver 30 is configured to acquire the ultrasonic wave energy at a second harmonic frequency. It should be noted that although the illustrated embodiment includes separate transmit and receiver elements, in other embodiments a single transducer may be used in a transmit and a receive mode to replace the separate transmit and receive elements shown in FIG. 2. Further, in certain embodiments, the ultrasonic transducer 28 and the ultrasonic receiver 30 may be coupled directly to a component such as the fan disk 10 of FIG. 1 to facilitate non-destructive inspection of such component 10.

The ultrasonic inspection system 20 also includes a processor 32 configured to generate a nonlinear image corresponding to a material property variation of the part 26 using the received ultrasonic wave energy from the ultrasonic receiver 30. Further, the processor 32 is configured to use the generated nonlinear image of the part 26 to determine whether one or more material anomalies are present in the part. In this exemplary embodiment, the material anomaly corresponds to a low cycle fatigue. In certain other embodiments, the material anomalies correspond to high cycle fatigue, fretting fatigue, alpha case in Ti, hard alpha, small flaws and combinations thereof. In addition, the ultrasonic inspection system 20 may include a display unit configured to display the generated nonlinear image of the part 26.

It should be noted that the present invention is not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art.

The nonlinear image generated by the processor 32 includes a plurality of pixels. Further, the processor 32 is configured to determine one of a color or a grey value associated with each pixel as a function of amplitudes of the received ultrasonic wave energy at a fundamental frequency and a second harmonic frequency that will be described in a greater detail below.

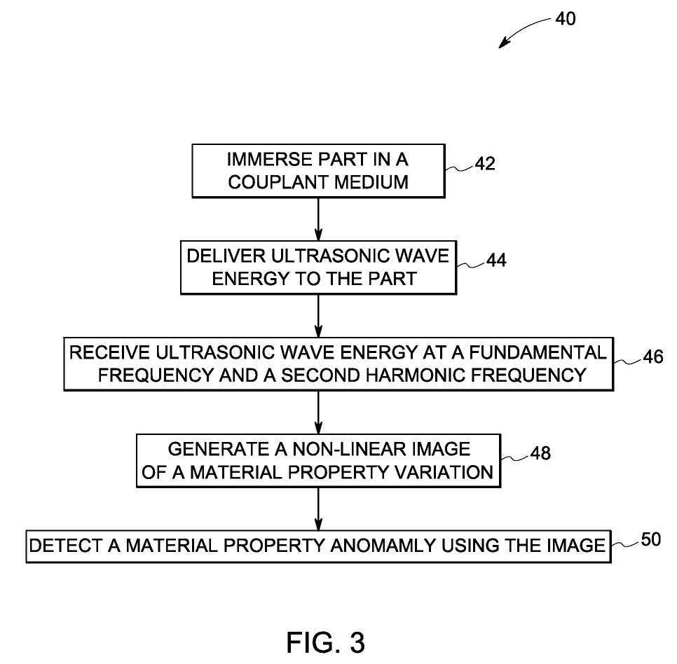

FIG. 3 is a flow chart illustrating an ultrasonic inspection method 40. The inspection method 40 includes immersing a part in a couplant medium (step 42). In one embodiment, the part is completely immersed in the couplant medium. Alternatively, the part is partially immersed in the couplant medium. At step 44, ultrasonic wave energy is delivered to the part using an ultrasonic transducer. Further, at step 46, the ultrasonic wave energy from the part is received at a fundamental frequency and a second harmonic frequency using an ultrasonic receiver. In the illustrated embodiment, the ultrasonic transducer and the ultrasonic receiver are at least partially immersed in the couplant medium. Further, the ultrasonic receiver is configured to receive the ultrasonic wave energy at the second harmonic frequency at its minimal attenuation in the couplant medium.

The received ultrasonic wave energy at the fundamental and second harmonic frequencies is utilized to generate a nonlinear image of a material property variation of the part (step 48). In particular, the nonlinear image includes a plurality of pixels and one of a color and a gray value of each of the pixels is determined as a function of the amplitudes of the received ultrasonic wave energy at the fundamental and second harmonic frequencies. Further, the nonlinear image is presented as a beta image that is a function of amplitude data at the fundamental and second harmonic frequencies. In one embodiment, the nonlinear image is constructed in accordance with the following equation:

β=(8/ak²)(A₂/A₁²) (1)

where:

A2 is the amplitude of the received ultrasonic wave energy at the second harmonic frequency;

A₁ is the amplitude of the received ultrasonic wave energy at the fundamental frequency;

k=2π/λ;

λ is the wavelength; and

a is a sample thickness.

At step 50, the nonlinear image is utilized to determine whether one or more material property anomalies are present in the part. As described above, the material anomalies may correspond to failure mechanisms such as low cycle fatigue, high cycle fatigue, fretting fatigue, alpha case in Ti, hard alpha, small flaws and combinations thereof. However, material anomalies corresponding to a variety of other failure mechanisms may be determined using the inspection technique described above.

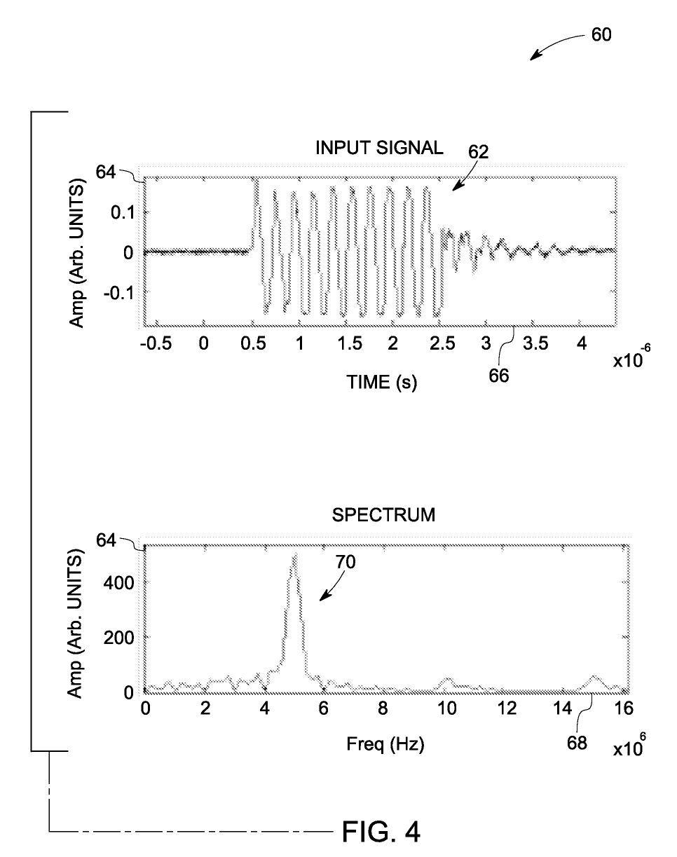

FIG. 4 illustrates an exemplary input signal 60 delivered to an inspection part such as the low cycle fatigue specimen 12 of FIG. 1 using the ultrasonic inspection system 20 of FIG. 2. In the illustrated embodiment, the input signal is represented by an exemplary profile 62, which is a graphical representation of amplitude 64 with respect to time 66. Further, the input signal may also be represented as a variation of the amplitude 64 with respect to a frequency 68, as represented by the exemplary profile 70. In operation, the input signal 60 is delivered to insonify at least one subvolume of the low cycle fatigue specimen 12 that is at least partially immersed in the couplant medium 24 (see FIG. 2). In this exemplary embodiment, the input signal is a pure tone signal and is transmitted at a fundamental frequency of about 5 MHz. In certain other embodiments, the input signal includes a chirp signal, or a spike pulse signal and combinations thereof.

The input signal 60 is delivered to the low cycle fatigue specimen 12 using an ultrasonic transducer 28 (see FIG. 2) that is immersed in the couplant medium 24. In certain embodiments, the input signal 60 may be transmitted repeatedly into the subvolume of the low cycle fatigue specimen 12 at different pulser voltage levels. Further, corresponding amplitudes of the received ultrasonic wave energy at the second harmonic frequency are measured for each of the different pulser voltage levels for generating the nonlinear image.

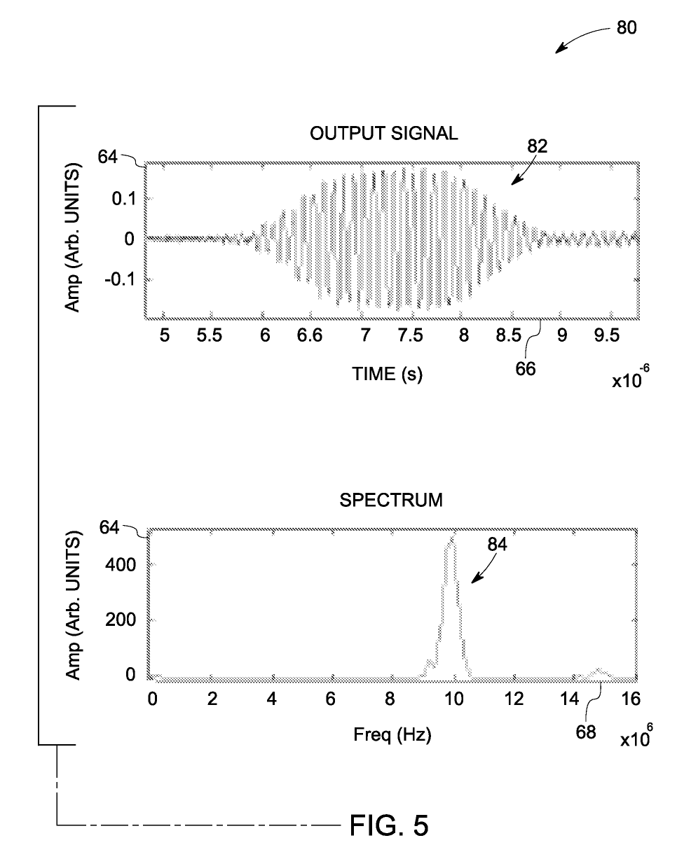

The ultrasonic wave energy from the low cycle fatigue specimen 12 is acquired using the ultrasonic receiver 30 (see FIG. 1) that is immersed in the couplant medium 24. FIG. 5 illustrates an exemplary output signal 80 received from the low cycle fatigue specimen 12 of FIG. 1. Again, profiles 82 and 84 represent variation of amplitude with time and frequency respectively. As can be seen, the output signal 80 from a damaged region of the low cycle fatigue specimen 12 has a significant second harmonic component associated therewith. It should be noted that when the input signal 60 is delivered to an undamaged area of the low cycle fatigue specimen 12 there will be a negligible amount of second harmonic distortion on the output signal 80. As described above, the amplitude data from the output signal 80 is acquired at the second harmonic frequency and the nonlinear image is constructed as a beta image that is a function of amplitude data at the fundamental and second harmonic frequencies. Further, the generated nonlinear image is utilized to determine whether one or more material property anomalies are present in the low cycle fatigue specimen 12. In this exemplary embodiment, the material property anomaly corresponds to low cycle fatigue.

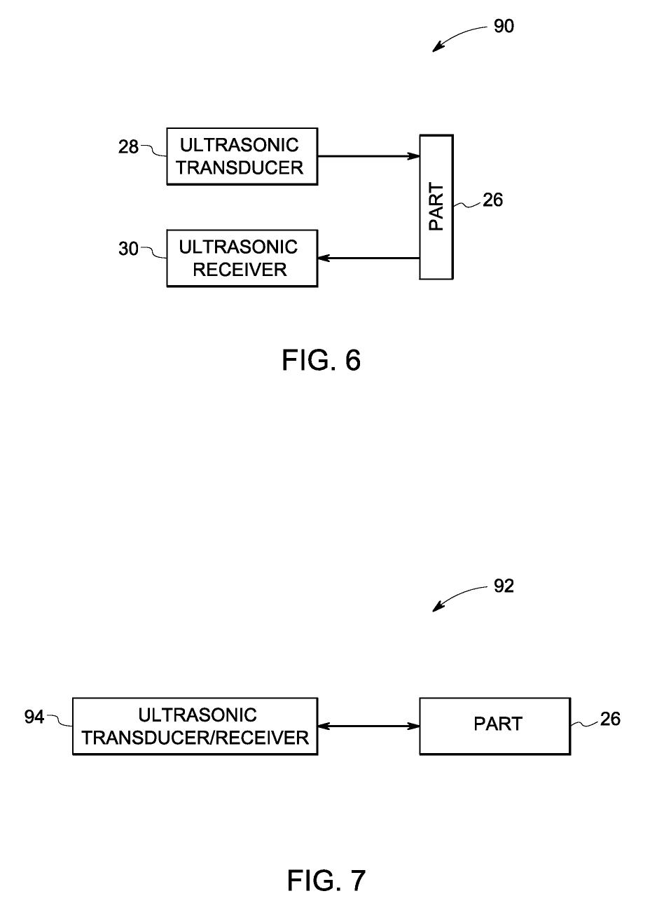

As described above with reference to FIG. 2, the inspection system 20 includes the ultrasonic transducer 28 and the ultrasonic receiver 30 for delivering and receiving ultrasound wave energy from the part 26. In the illustrated embodiment, the ultrasonic transducer 28 and the ultrasonic receiver 30 are located on opposite sides of the part 26. However, a variety of other configurations may be envisaged for transmitting and receiving the ultrasonic wave energy from the part 26. For example, in an exemplary configuration illustrated in FIG. 6, the ultrasonic transducer 28 and the ultrasonic receiver 30 may be located on the same side of the part 26. Similarly, in an exemplary configuration 92 illustrated in FIG. 7, a single ultrasonic transducer 94 may be employed for both delivering and receiving the ultrasonic wave energy from the part 26. In this exemplary embodiment, the ultrasonic transducer 94 includes a single sided pulse echo transducer. Furthermore, distance of the ultrasonic transducer 28 and the ultrasonic receiver 30 may be adjusted to obtain an optimum configuration for generating the nonlinear image of the part 26.

In certain embodiments, the nonlinearity parameter ‘β’ described above with reference to equation 1 may be estimated using the received ultrasonic wave energy from the part 26. The nonlinearity parameter β is used to determine one or more material property anomalies corresponding to low cycle fatigue, high cycle fatigue, fretting fatigue, alpha case in Ti, hard alpha and small flaws.

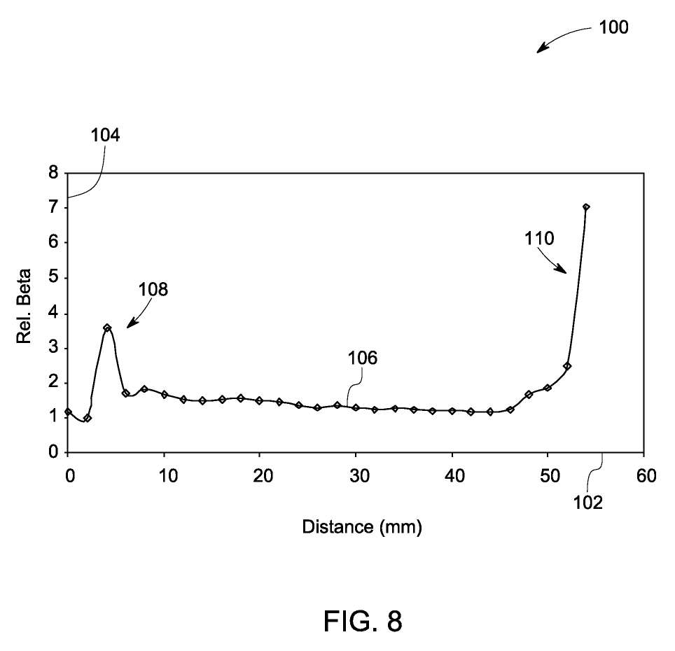

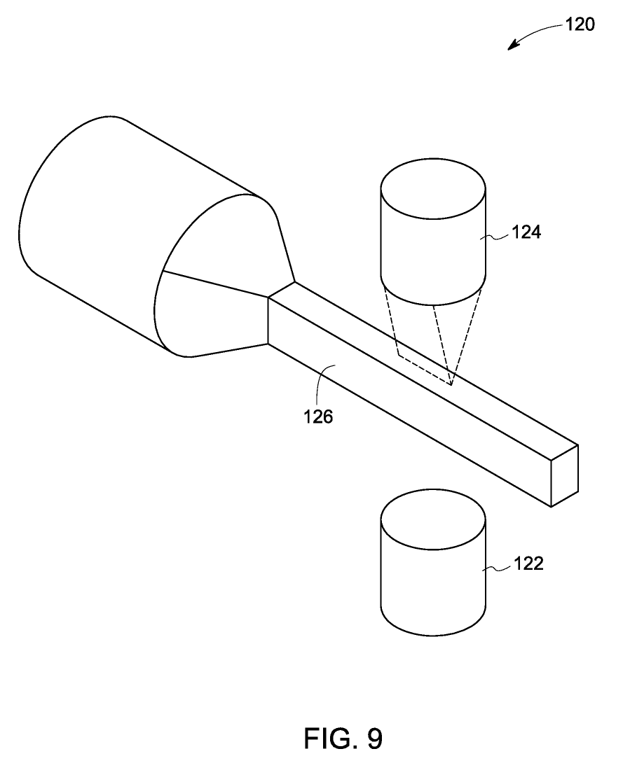

FIG. 8 is a graphical representation of exemplary values of β parameter 100 corresponding to low cycle fatigue damage obtained using the ultrasonic inspection system 20 of FIG. 2. The abscissa axis 102 represents distance from an end of the part 26 measured in millimeters (mm) and the ordinate axis 104 represents a relative value of the β parameter. In this exemplary embodiment, the ultrasound transducer 20 and the ultrasound receiver 30 include planar probes. In certain other embodiments, at least one of the ultrasound transducer 20 and the ultrasound receiver 30 includes a focused probe. The part 26 is subjected to about 5 cycles with an applied voltage level of about 30. In this embodiment, the ultrasound transducer 28 and the ultrasound receiver 30 are located on opposite sides of the part 26 at a distance of about 35 mm and 1 mm respectively from the part 26. However, a variety of other configurations of the inspection set up with different locations of the ultrasound transducer 28 and the ultrasound receiver 30 may be envisaged.

Further, the ultrasound transducer 28 and the ultrasound receiver 30 are configured to deliver and receive ultrasonic wave energy at a frequency of 5 MHz and 10 MHz respectively. The variation of the β parameter is represented by an exemplary profile 106 and is indicative of a material property anomaly. In this embodiment, the part 26 includes a weld in the material as indicated by a β value represented by reference numeral 108. Further, the low cycle fatigue damage of the part is indicated by a β value represented by reference numeral 110. Thus, the nonlinear image with estimation of the β parameter facilitates detection of material property anomalies in the part 26.

FIG. 9 illustrates another exemplary configuration 120 of an ultrasonic transducer 122 and an ultrasonic receiver 124 for the ultrasonic inspection system 20 of FIG. 2. In the illustrated embodiment, the ultrasonic transducer 122 and the ultrasonic receiver 124 are located on opposite sides of an inspection part 126. Further, the ultrasonic transducer 122 includes a planar probe and the ultrasonic receiver 124 includes a focused probe. Again, the distance of the planar and focused probes 122 and 124 may be adjusted to obtain an optimum configuration for generating the nonlinear image of the part 126 through the inspection system 20. Further, in one exemplary embodiment, the ultrasonic transducer 122 includes a focused probe and the ultrasonic receiver 124 includes a planar probe. Similarly, in another embodiment, both the ultrasonic transducer 122 and the ultrasonic receiver 124 may include focused probes.

The various aspects of the methods and systems described hereinabove have utility in different applications, such as in aerospace industry. The methods and systems described above allow detection of material property anomalies in parts using a nonlinear ultrasound imaging technique. In particular, the methods and systems utilize a nondestructive immersion technique to detect material property anomalies corresponding to life limiting processes such as low cycle fatigue, high cycle fatigue, fretting fatigue and so forth. Accordingly, parts in which failure is incipient can be detected more reliably and earlier than through conventional techniques thereby facilitating service assessment of remaining life of the parts. Moreover, since these methods and systems employ nondestructive inspection techniques, the costs for conducting the inspection are also reduced.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for inspecting a part, the method comprising:
immersing the part in a couplant medium;
delivering ultrasonic wave energy to at least one subvolume of the part using an ultrasonic transducer immersed in the couplant medium;
receiving ultrasonic wave energy from the part at a fundamental frequency and at least one harmonic frequency using an ultrasonic receiver immersed in the couplant medium;
generating a nonlinear image corresponding to at least one material property variation of the part using the received ultrasonic energy; and
using the nonlinear image of the part to determine whether one or more material property anomalies are present in the part.

2. The method of claim 1, wherein the receiving step comprises acquiring amplitude data at a second harmonic frequency.

3. The method of claim 1, wherein the nonlinear image comprises a plurality of pixels, and wherein the generating step comprises determining one of a color and a gray value of each of the pixels as a function of the amplitudes of the received ultrasonic wave energy at the fundamental and harmonic frequencies.

4. The method of claim 3, wherein the receiving step comprises acquiring amplitude data at a second harmonic frequency, and wherein the nonlinear image is a beta image constructed in accordance with an expression:
β=(8/ak²)(A₂/A₁²)
wherein A₂ is the amplitude of the received ultrasonic wave energy at the second harmonic frequency, A₁ is the amplitude of the received ultrasonic wave energy at the fundamental frequency, k=2π/λ, wherein λ is the wavelength and a is a sample thickness.

5. The method of claim 1, wherein the material property anomalies correspond to a low cycle fatigue (LCF), or a high cycle fatigue (HCF), or fretting fatigue, or alpha case in Ti, or hard alpha, or small flaws, or grain and colony size, or combinations thereof.

6. The method of claim 1, wherein the generating step comprises generating a Beta C-scan for visualization of damage accumulation in the part.

7. The method of claim 1, further comprising estimating a service life of the part based upon the material property variation of the part.

8. The method of claim 1, further comprising adjusting a temperature of the couplant medium for enhancing a signal-to-noise ratio of a plurality of signals received from the part.

9. A system for inspecting a part, comprising:
a container at least partially filled with a couplant medium and having the part immersed therein;
an ultrasonic transducer immersed in the couplant medium and configured to deliver ultrasonic wave energy to at least one sub volume of the part;
an ultrasonic receiver immersed in the couplant medium and configured to receive ultrasonic wave energy from the part at a fundamental frequency and at least one harmonic frequency; and
a processor configured to generate a nonlinear image corresponding to a material property variation of the part using the received ultrasonic energy and to use the image of the part to determine whether one or more material property anomalies are present in the part.

10. The system of claim 9, wherein the nonlinear image comprises a plurality of pixels, and wherein the processor is configured to determine one of a color or a grey value associated with each pixel as a function of the amplitudes of the received ultrasonic wave energy at the fundamental frequency and a second harmonic frequency.

11. The system of claim 9, wherein the material property anomalies correspond to a low cycle fatigue (LCF), or a high cycle fatigue (HCF), or fretting fatigue, or alpha case in Ti, or hard alpha, or small flaws, or grain and colony size, or combinations thereof

12. The system of claim 9, further comprising a display unit configured to display the nonlinear image of the part.

13. The system of claim 9, wherein the nonlinear image is a beta image constructed in accordance with an expression:
β=(8/ak²)(A₂/A₁²)
wherein A₂ is the amplitude of the received ultrasonic wave energy at the second harmonic frequency, A₁ is the amplitude of the received ultrasonic wave energy at the fundamental frequency, k=2π/λ, wherein λ is the wavelength and a is a sample thickness.

14. The system of claim 9, wherein the ultrasonic transducer is configured to deliver the ultrasonic energy at a frequency of about 5 MHz.

15. The system of claim 9, wherein the ultrasonic receiver is configured to receive the ultrasonic energy from the part at a frequency in a range of about 5 MHz to about 10 MHz.

16. The system of claim 9, wherein the ultrasonic receiver is disposed at a distance from the part that is substantially lesser than a distance of the ultrasonic transducer from the part.
